(19) United States
(12) Patent Application Publication
(10) Pub. No.: US 2026/0202045 A1
(43) Pub. Date: Jul. 16, 2026

(54) LED LAMP AND LED PRODUCT

(71) Applicant: GUANGDONG OPSCO TECHNOLOGY CO., LTD, Dongguan (CN)

(72) Inventors: MINGJIAN LIU, Dongguan (CN); XIAOLIANG LI, Dongguan (CN); GENGSHENG ZHU, Dongguan (CN)

(21) Appl. No.: 19/560,180

(22) Filed: Mar. 9, 2026

Related U.S. Application Data
(63) Continuation of application No. PCT/CN2023/118849, filed on Sep. 14, 2023.

(51) Int. Cl. F21V 23/00; F21K 9/27; F21Y 103/10; F21Y 115/10

(52) U.S. Cl. CPC F21V 23/002; F21K 9/27; F21Y 2103/10; F21Y 2115/10

(57) ABSTRACT

The present application discloses an LED lamp, comprising a wire set, a composite tube made of a light-transmitting material, and at least two LED lamp beads. The wire set includes a signal wire and a power wire. The at least two LED lamp beads are sequentially arranged and mounted on the signal wire and the power wire to form an LED strip, and two adjacent LED lamp beads are connected in series. The composite tube is coated on an outer side of the LED strip and the LED lamp beads through an extrusion process. The composite tube includes a cable wire and a hollow tube, the cable wire is configured to compensate for voltage drop loss generated after the power wire supplies power to the LED lamp beads, and the hollow tube is integrally formed and coated on an outer side of the cable wire.

### CROSS-REFERENCE TO RELATED APPLICATIONS

The application is a National Stage of International Application No. PCT/CN2023/118849 , filed on September 14 , 2023, the entire contents of which are herein incorporated by reference.

### TECHNICAL FIELD

The present application relates to the technical field of LED products, and in particular relates to an LED lamp and an LED product.

### BACKGROUND

LED lamps have advantages such as energy saving, low power consumption, high efficiency, fast response time, long service life, and environmental friendliness, and are widely used in decoration and lighting, adding enjoyment and atmosphere to various festive activities. However, in existing LED lamps, LED lamp beads are mounted on a PCB board and then installed into a composite tube, and are manually soldered to wires, which is inconvenient in operation. In some cases, it is even necessary to strip the composite tube on an outer side of the wires before soldering.

### SUMMARY OF THE INVENTION

The present application provides an LED lamp and an LED product.

According to a first aspect, the present application provides an LED lamp including a wire set, a composite tube made of a light-transmitting material, and at least two LED lamp beads. The wire set includes a signal wire and a power wire. The at least two LED lamp beads are sequentially arranged and mounted on the signal wire and the power wire to form an LED strip, and two adjacent LED lamp beads are connected in series. The composite tube is coated on an outer side of the LED strip and the LED lamp beads through an extrusion process.

The composite tube includes a cable wire and a hollow tube, the cable wire is configured to compensate for voltage drop loss generated after the power wire supplies power to the LED lamp beads, and the hollow tube is integrally formed and coated on an outer side of the cable wire. The LED strip is disposed in a cavity formed by the hollow tube, such that light emitted by the LED lamp beads is capable of passing through the hollow tube and being transmitted to an outside of the hollow tube.

In some embodiments, the cable wire is a metal wire, the metal wire is wrapped between an inner wall and an outer wall of the hollow tube, the LED strip is wrapped in the cavity formed by the inner wall of the hollow tube, and the LED strip and the metal wire are electrically insulated from each other inside the hollow tube.

In some embodiments, the cable wire includes a first power wire and a second power wire, and the first power wire and the second power wire are arranged along a length direction of the hollow tube and symmetrically disposed on two sides of the hollow tube.

In some embodiments, wherein the power wire includes a positive power wire and a negative power wire, the positive power wire is connected to a positive pin of the LED lamp bead, the negative power wire is connected to a negative pin of the LED lamp bead, and an encapsulant is formed on an outer side of the LED lamp beads through a dispensing process.

In some embodiments, the encapsulant at least wraps an outer side of connection points where the LED lamp beads join the positive power wire and the negative power wire respectively.

In some embodiments, the signal wire includes a signal output wire and a signal input wire, the signal output wire is connected to a signal output pin of the LED lamp beads, and the signal input wire is connected to a signal input pin of the LED lamp beads.

In some embodiments, the positive power wire, the negative power wire, the signal output wire, and the signal input wire are arranged in parallel side by side to form a ribbon cable structure, and the positive power wire and the negative power wire are respectively located at two outer sides of the ribbon cable structure.

In some embodiments, the LED lamp further includes connection terminals electrically connected to the signal wire and the power wire, and the connection terminals are connected to two ends of the composite tube through an injection molding process.

In some embodiments, the connection terminals include a first connection terminal and a second connection terminal that cooperate with each other, the first connection terminal is disposed at one end of the composite tube, and the second connection terminal is disposed at another end of the composite tube;

the first connection terminal is provided with a positive connector, a negative connector, and a signal input connector; the second connection terminal is provided with a positive connection port, a negative connection port, and a signal output connector; the positive power wire of the power wire and a first power wire of the cable wire are connected to the positive connector and the positive connection port, the negative power wire of the power wire and a second power wire of the cable wire are connected to the negative connector and the negative connection port; the signal input connector is connected to the signal input wire of the signal wire, the signal output connector is connected to the signal output wire of the signal wire; and the signal output pin of one LED lamp bead is electrically connected to the signal input pin of adjacent LED lamp bead.

According to a second aspect, the present application provides an LED product including a plurality of LED above-mentioned, wherein the LED lamps are connected to each other through connection terminals on the composite tubes, and voltage drop loss generated on the power wire of the LED lamp beads is compensated through the cable wire between two adjacent LED lamps.

### BRIEF DESCRIPTION OF THE DRAWINGS

In order to describe the technical solutions of embodiments of the present application more clearly, the drawings required to be used in the description of the embodiments are briefly introduced below. The drawings described below are some embodiments of the present application. For those of ordinary skill in the art, other drawings may also be obtained based on these drawings without creative effort.

FIG. 1 is a schematic structural view of an LED lamp according to an embodiment of the present application;

FIG. 2 is an exploded schematic view of the LED lamp shown in FIG. 1;

FIG. 3 is a cross-sectional schematic view of the LED lamp shown in FIG. 1;

FIG. 4 is a schematic structural view of a hollow tube shown in FIG. 1;

FIG. 5 is a schematic structural view of a wire set, LED lamp beads, and a cable wire shown in FIG. 1;

FIG. 6 is an exploded schematic view of the wire set, the LED lamp beads, and the cable wire shown in FIG. 1;

FIG. 7 is a schematic structural view of a first connection terminal shown in FIG. 1;

FIG. 8 is a schematic structural view of a second connection terminal shown in FIG. 1.

### Reference Numerals

100: LED lamp;

10: wire set; 11: power wire; 111: positive power wire; 112: negative power wire; 12: signal wire; 121: signal output wire; 122: signal input wire;

20: LED lamp bead;

30: hollow tube; 31: cavity;

40: cable wire; 41: first power wire; 42: second power wire;

50: connection terminal; 51: first connection terminal; 52: second connection terminal.

### DETAILED DESCRIPTION

The technical solutions of the embodiments of the present application are described clearly and completely below with reference to the drawings in the embodiments of the present application. The described embodiments are part of the embodiments of the present application, rather than all of the embodiments. Based on the embodiments of the present application, all other embodiments obtained by those of ordinary skill in the art without creative effort fall within the protection scope of the present application.

It should also be understood that the terms used in the specification of the present application are for describing specific embodiments. In the description of the present application, the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, and “counterclockwise” indicate orientations or positional relationships based on the orientations or positional relationships shown in the drawings, and are for convenience of description and simplification of the description, rather than indicating or implying that the device or element referred to is required to have a particular orientation, or be constructed and operated in a particular orientation, and therefore should not be construed as limiting the present application.

In addition, the terms “first” and “second” are used for descriptive purposes and should not be construed as indicating or implying relative importance or implicitly indicating the number of the technical features indicated. Thus, features defined with “first” or “second” may explicitly or implicitly include one or more of such features. In the description of the present application, “a plurality of” means two or more, unless otherwise expressly and specifically defined.

The present application provides an LED lamp and an LED product, which enable LED lamp beads that have been soldered to a wire set to be disposed in a cavity formed by a hollow tube, and then compensate power supplied to the LED lamp beads through power wires of the hollow tube. There is no need to strip the composite tube and solder the LED lamp beads in the cavity to the wire set one by one, enabling mass production and reducing manufacturing costs.

Some embodiments of the present application are described in detail below with reference to the drawings. In the absence of conflict, the embodiments and features in the embodiments described below may be combined with each other.

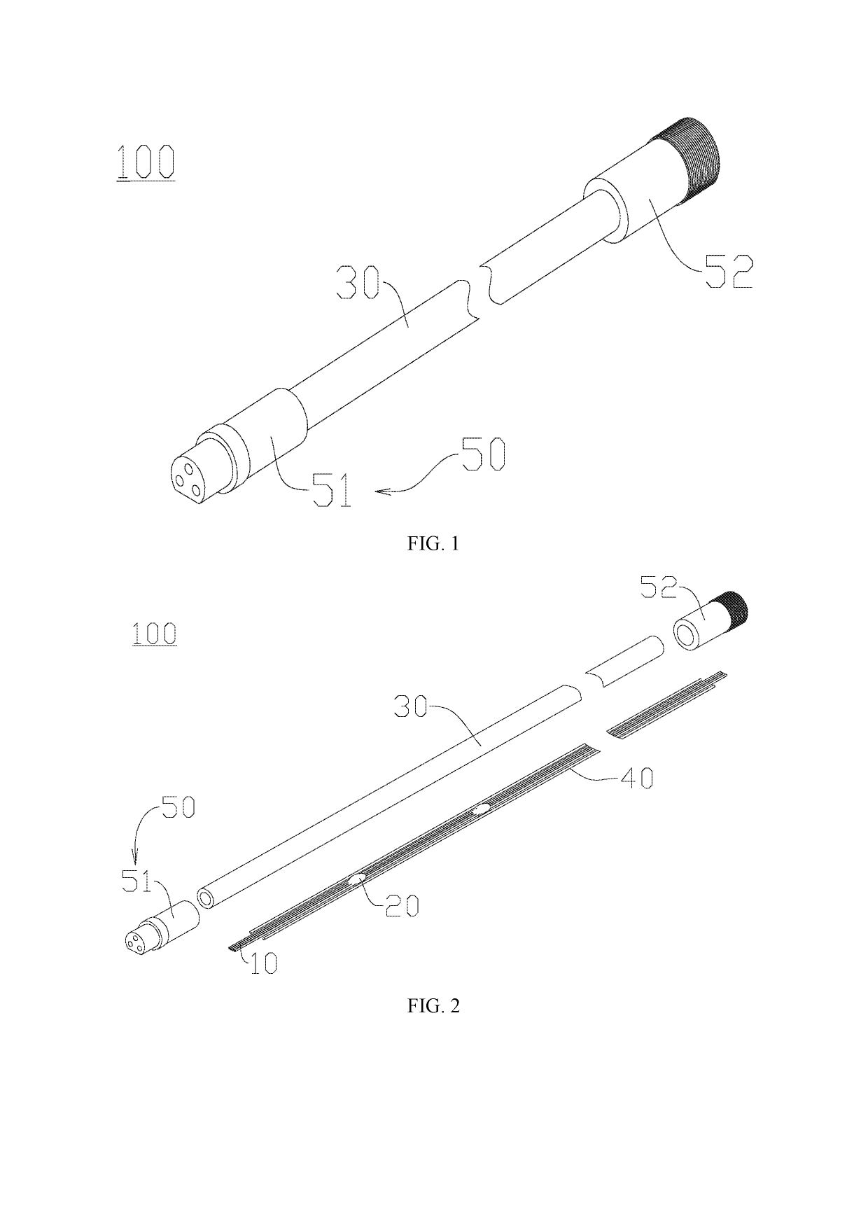

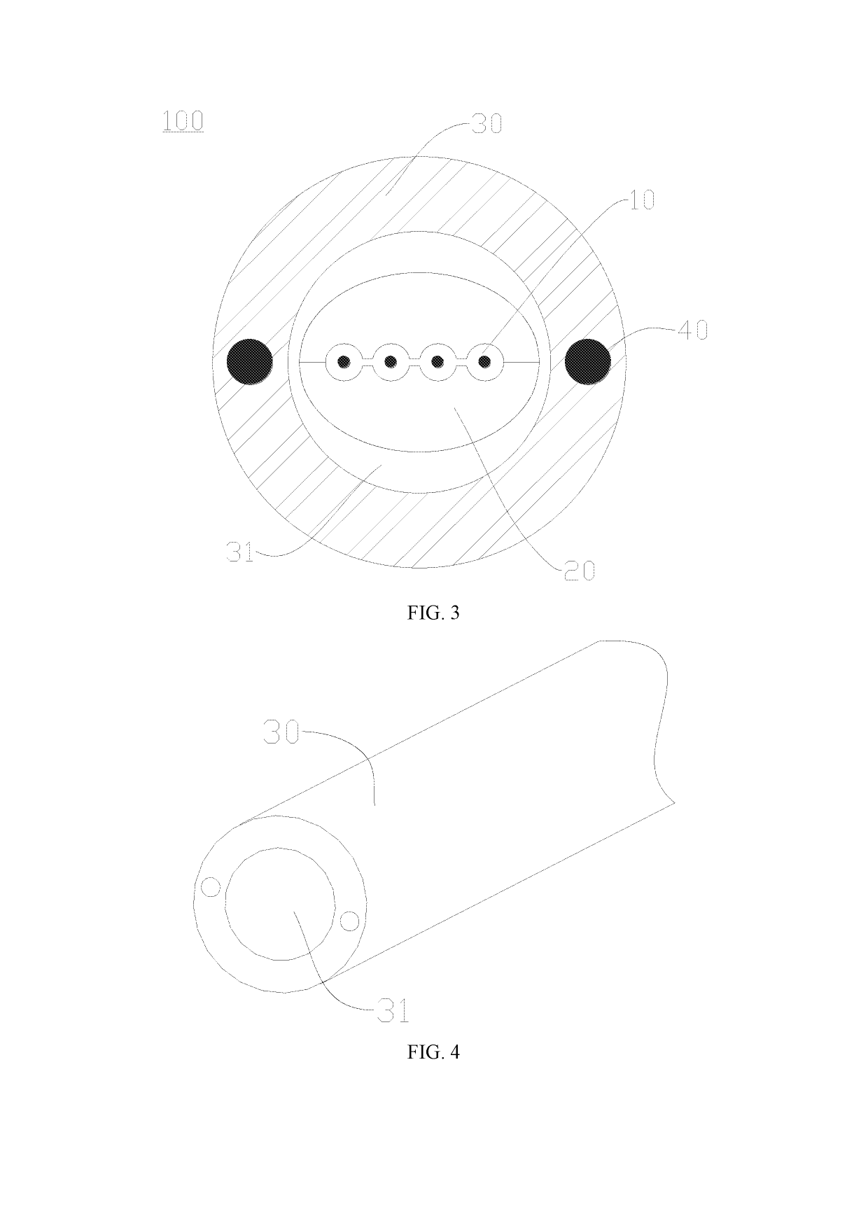

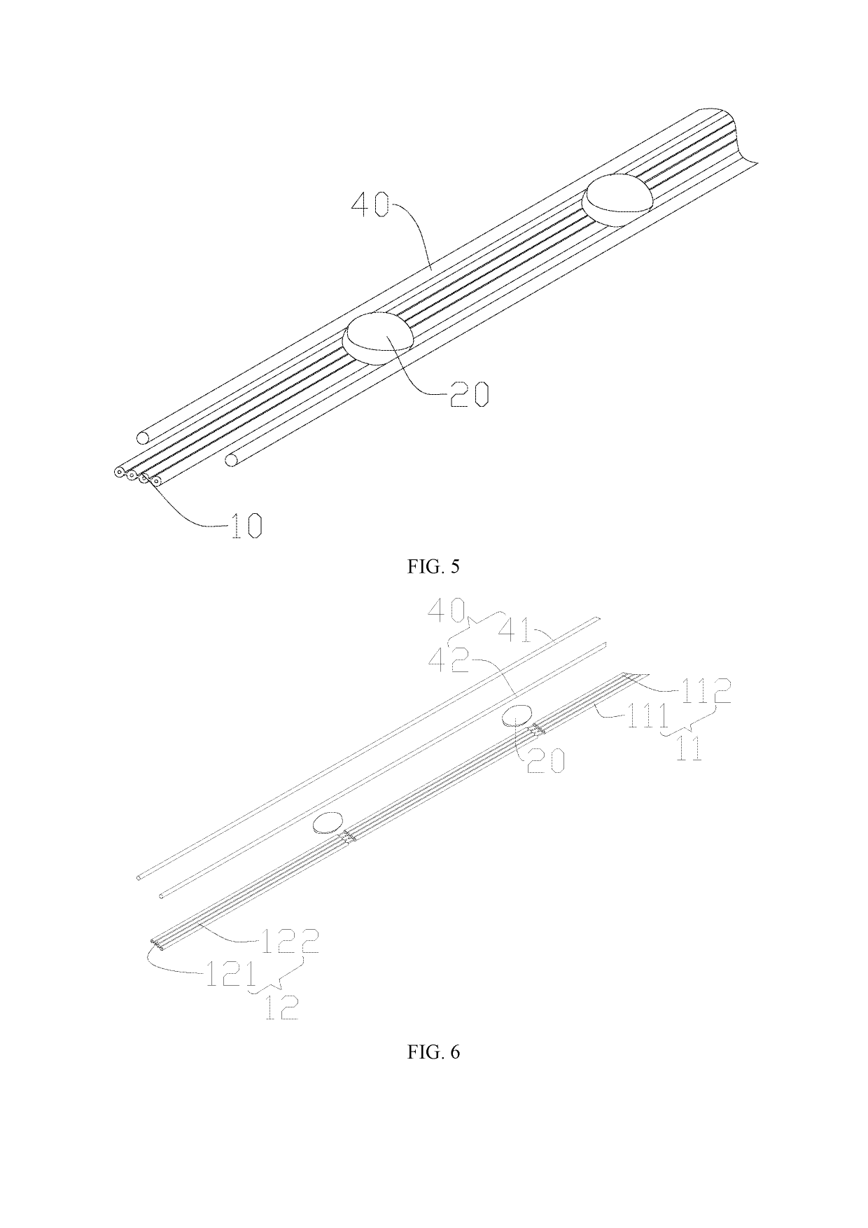

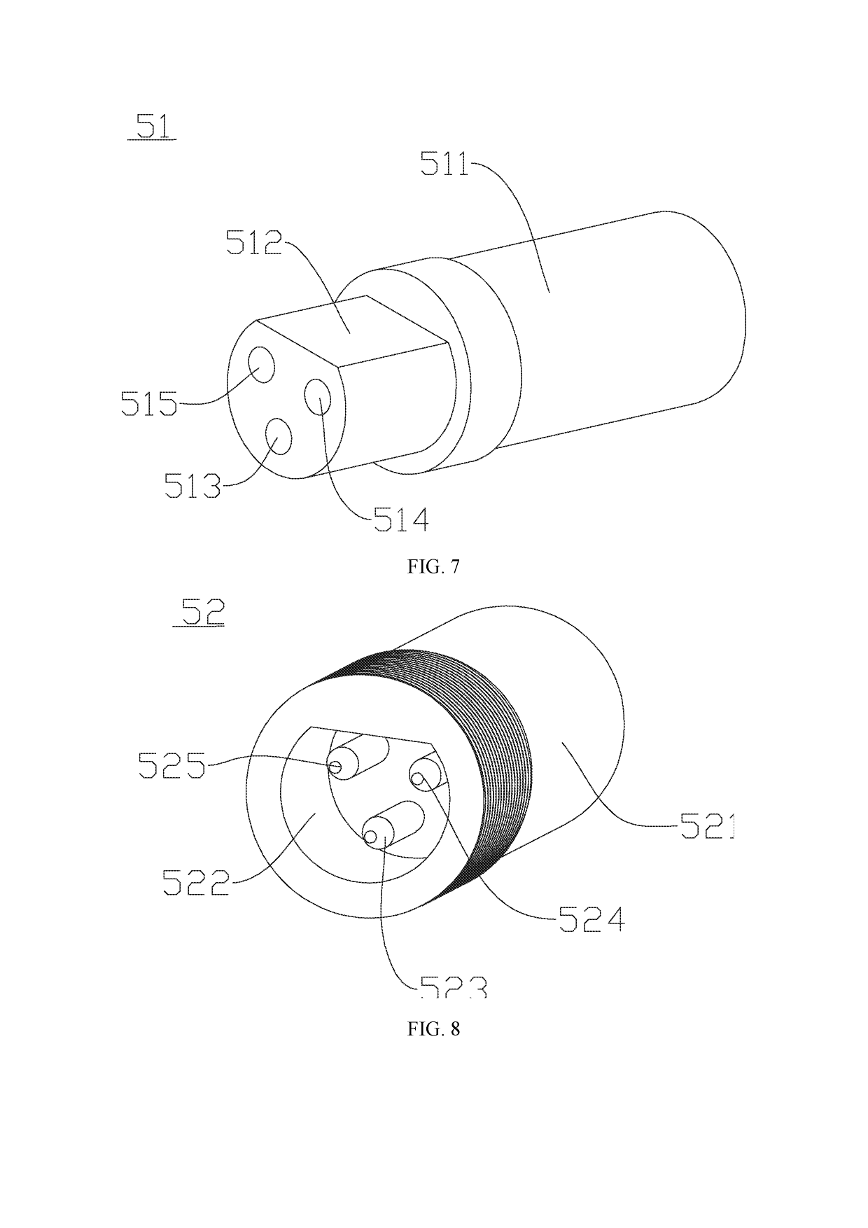

As shown in FIGS. 1 to 8, according to the first aspect of the present application, the present application provides an LED lamp 100, including a wire set 10, a composite tube made of a light-transmitting material, and at least two LED lamp beads 20. The wire set 10 includes a signal wire 12 and a power wire 11. The at least two LED lamp beads 20 are sequentially arranged and mounted on the signal wire 12 and the power wire 11 to form an LED strip, such that the power wire 11 is capable of supplying driving voltage to the LED lamp beads 20, and the signal wire 12 is capable of supplying driving signals to the LED lamp beads 20 to control light-emitting effects of the LED lamp beads.

In this embodiment, two adjacent LED lamp beads 20 are connected in series. The composite tube is coated on an outer side of the LED strip through an extrusion process, which is capable of uniformizing light and avoiding visible bright spots of the LED lamp beads 20, reducing glare, realizing 360-degree omnidirectional illumination, achieving continuous and uniform lighting effects with high light output efficiency. In addition, the wire set 10 and the LED lamp beads 20 are protected, and the structure is simple with low production cost.

In some embodiments, the composite tube includes a cable wire 40 and a hollow tube 30 integrally formed and coated on an outer side of the cable wire 40. The LED strip is disposed in a cavity 31 formed by the hollow tube 30. The cable wire 40 is configured to compensate for voltage drop loss generated after the power wire 11 supplies power to the LED lamp beads 20, thereby ensuring normal operation of the LED lamp beads 20, and enabling light emitted by the LED lamp beads 20 to pass through the hollow tube 30 and be transmitted to an outside of the hollow tube 30.

In some embodiments, the cable wire 40 includes a conductive wire core. When a material for forming the hollow tube 30 is extruded from an extruder, the conductive wire core is guided into a wire-passing mold core at a front end of the extruder, the hollow tube 30 is extruded from the wire-passing die core, and then the conductive wire core and the hollow tube 30 are pulled by a traction mechanism, such that the conductive wire core and the hollow tube 30 coated on an outer side of the conductive wire core move along a preset direction. The wrapping effect is good and the process is simple.

The LED strip welded with the LED lamp beads 20 may be wrapped inside the cavity 31 of the hollow tube 30 and pulled together with the hollow tube 30 by the traction mechanism; alternatively, the LED strip welded with the LED lamp beads 20 may be inserted into the cavity 31 inside the hollow tube 30 after the hollow tube 30 is formed. The present application is not limited thereto.

In some embodiments, the cable wire 40 is a metal wire. The metal wire is wrapped between an inner wall and an outer wall of the hollow tube 30, without requiring insulation treatment for the metal wire. The LED strip is wrapped in the cavity 31 formed by the inner wall of the hollow tube 30, and the LED lamp beads 20 and the metal wire are electrically insulated from each other inside the hollow tube 30. That is, the LED lamp beads 20 are electrically connected to the signal wire 12 and the power wire 11 inside the hollow tube 30, and the metal wire is configured to provide power compensation for another LED lamp 100 connected thereto.

In some embodiments, after the hollow tube 30 is formed, the hollow tube 30 and the LED strip disposed in the cavity 31 are cut, and connection terminals 50 are respectively disposed at two ends of the cut hollow tube 30 to form the LED lamp 100. The LED strip is disposed in the cavity formed by the hollow tube 30 and the connection terminals 50. The metal wire and the power wire 11 are connected to power interfaces of the connection terminals 50, and the signal wire 12 is connected to signal interfaces of the connection terminals 50. In this manner, a length of the LED lamp 100 and a number of LED lamp beads 20 in the LED lamp 100 may be set according to requirements.

Since a voltage required by each LED lamp bead 20 is fixed, a voltage required by the LED lamp 100 is also fixed. For example, when an operating voltage of each LED lamp bead 20 is 3 V and the number of LED lamp beads 20 in the LED lamp 100 is eight, the eight LED lamp beads 20 are connected in series in the cavity 31, and a required operating voltage of the LED lamp 100 is 24 V.

When multiple LED lamps 100 are connected together through the connection terminals 50, it is necessary to input the required operating voltage of the LED lamp 100, such as 24 V, to one LED lamp 100 through the power interface of the connection terminal 50. Power compensation is performed between the LED lamps 100 through the cable wire 40, such that the operating voltage in each LED lamp 100 is maintained consistent, thereby ensuring normal operation of the LED lamp beads 20 in each LED lamp 100.

In some embodiments, the cable wire 40 includes a first power wire 41 and a second power wire 42. The first power wire 41 and the second power wire 42 are arranged along a length direction of the hollow tube 30 and symmetrically disposed on two sides of the hollow tube 30, so as to disperse distribution of the metal wires on the inner wall of the hollow tube 30 and avoid shielding of light emitted by the LED lamp beads 20 due to aggregation of the metal wires.

A plane formed by the LED strip in a width direction coincides with a plane in which the first power wire 41 and the second power wire 42 are located. The plane in which the first power wire 41 and the second power wire 42 are located divides the hollow tube 30 into two semicircular structures with equal areas. The LED lamp beads 20 face one of the semicircular structures and emit light toward the semicircular structure, and then the light is uniformly diffused through the hollow tube 30 to form a 360-degree light tube with good lighting effects. The LED lamp may be widely applied to decoration, landscape lighting, advertising signs, and also used as a decorative ambient light source or for illumination.

In some embodiments, the power wire 11 includes a positive power wire 111 and a negative power wire 112. The positive power wire 111 is connected to a positive pin of the LED lamp beads 20, and the negative power wire 112 is connected to a negative pin of the LED lamp beads 20. An encapsulant is formed on an outer side of the LED lamp beads 20 through a dispensing process, thereby forming a protective structure for the LED lamp beads 20 and the power wire 11, improving sealing performance of the LED lamp beads 20 and facilitating outdoor use.

In some embodiments, the encapsulant at least wraps an outer side of connection points where the LED lamp beads 20 join the positive power wire 111 and the negative power wire 112 respectively, so as to protect the LED lamp beads 20 and the connection points between the LED lamp beads 20 and the power wire 11. In this manner, when the power wire 11 is bent, the LED lamp beads 20 and the connection points are not easily affected, reliability in use is improved, and sealing performance of the LED lamp 100 is enhanced, especially when liquid enters the cavity 31, which is suitable for outdoor use.

Since the encapsulant is encapsulated on an outer side of the LED lamp beads 20 and the connection points, the LED lamp beads 20 and the connection points are protected and are not easily damaged during bending or small stretching, thereby improving reliability of the light strip. The encapsulation structure is simple and manufacturing cost is lower.

In some embodiments, hardness of the encapsulant is higher than hardness of the hollow tube 30, such that when the hollow tube 30 is bent, the encapsulant is not easily deformed by bending.

In some embodiments, the encapsulant is a transparent encapsulant or an encapsulant of a specific color, and different color rendering of the LED lamp beads is achieved through the encapsulant to meet different use requirements with greater flexibility.

In some embodiments, the encapsulant may be a transparent encapsulant, a fluorescent encapsulant, a red encapsulant, an amber encapsulant, or the like. Each LED lamp bead 20 in the LED lamp 100 may also be configured with encapsulants of different colors to achieve different light-emitting color rendering effects. The LED lamp beads 20 may be color-adjustable as required to meet different use requirements.

In some embodiments, the encapsulant is formed by dispensing adhesive onto the LED lamp beads 20 through a dispensing machine, enabling automated production with mature processes and relatively low cost. In practical implementations, the encapsulant may also be formed by manual dispensing, which is not described in detail herein.

In some embodiments, a gap exists between an inner wall of the hollow tube 30 and the LED lamp beads 20, such that when the light strip is bent, the LED strip is not easily pulled, thereby improving reliability in use.

In some embodiments, the signal wire 12 includes a signal output wire 121 and a signal input wire 122. The signal output wire 121 is connected to a signal output pin of the LED lamp beads 20, and the signal input wire 122 is connected to a signal input pin of the LED lamp beads 20, and is configured to control light emission of the LED lamp beads 20.

In some embodiments, the positive power wire 111, the negative power wire 112, the signal output wire 121, and the signal input wire 122 are arranged in parallel side by side to form a ribbon cable structure. The positive power wire 111 and the negative power wire 112 are respectively located at two outer sides of the ribbon cable structure, facilitating corresponding connection between the positive power wire 111 and the negative power wire 112 and the first power wire 41 and the second power wire 42.

In some embodiments, the LED lamp 100 further includes connection terminals 50 electrically connected to the signal wire 12 and the power wire 11. The connection terminals 50 are connected to two ends of the composite tube through an injection molding process. The connection terminals 50 may be used to electrically connect external control equipment or auxiliary batteries, such that the control equipment is capable of controlling light emission of the LED lamp 100 and the auxiliary batteries are capable of supplying power to the LED lamp 100.

The connection terminals 50 may also be used for mutual connection between multiple LED lamps 100, such that multiple LED lamps 100 are connected in parallel through the signal wire 12 and the power wire 11, and the first power wire 41 and the second power wire 42 compensate for power loss during operation of the LED lamps 100.

Since the connection terminals 50 are connected to two ends of the composite tube through an injection molding process, sealing performance of the LED lamp 100 is ensured, such that the LED lamp beads 20, the signal wire 12, and the power wire 11 are sealed in a closed cavity formed by the composite tube and the connection terminals 50, thereby expanding application scenarios of the LED lamp 100, such as underwater installation.

In some embodiments, the connection terminals 50 include a first connection terminal 51 and a second connection terminal 52 that cooperate with each other. The first connection terminal 51 is disposed at one end of the composite tube, and the second connection terminal 52 is disposed at another end of the composite tube. Both the first connection terminal 51 and the second connection terminal 52 are provided with power interfaces and signal interfaces. The power wire 11 and the cable wire 40 are connected to the power interfaces, and the signal wire 12 is connected to the signal interfaces.

In this manner, external control equipment or auxiliary batteries are capable of being electrically connected to the LED lamp 100 through the signal interfaces and the power interfaces, or multiple LED lamps 100 are capable of being electrically connected to each other through the signal interfaces and the power interfaces.

Specifically, the power interfaces include a positive connector, a negative connector, a positive connection port, and a negative connection port. The signal interfaces include a signal input connector and a signal output connector. The positive connector, the negative connector, and the signal input connector are disposed on the first connection terminal 51. The positive connection port, the negative connection port, and the signal output connector are disposed on the second connection terminal 52.

The positive power wire 111 and the first power wire 41 are connected to the positive connector and the positive connection port. The negative power wire 112 and the second power wire 42 are connected to the negative connector and the negative connection port. The signal input connector is connected to the signal input wire 122, and the signal output connector is connected to the signal output wire 121. The signal output pin of one LED lamp bead is electrically connected to the signal input pin of adjacent LED lamp bead.

When two LED lamps 100 are connected, the positive connector, the negative connector, and the signal input connector on the first connection terminal 51 cooperate with the positive connection port, the negative connection port, and the signal output connector on the second connection terminal 52, thereby transmitting signals and power from one LED lamp 100 to another LED lamp 100. The first power wire 41 and the second power wire 42 perform power compensation to ensure normal operation of the LED lamp beads 20 in each LED lamp 100.

As shown in FIGS. 1 to 8, according to a second aspect of the present application, the present application provides an LED product, including multiple LED lamps 100 described above. The LED lamps 100 are connected to each other through the connection terminals 50 on the composite tubes. Voltage drop loss generated by the LED lamp beads 20 on the power wire 11 is compensated through the cable wire 40 between two adjacent LED lamps 100, avoiding impact of output voltage of one LED lamp 100 on normal operation of another LED lamp 100.

The technical solutions provided by the embodiments of the present application may include the following beneficial effects: the present application provides an LED lamp and an LED product, the LED lamp includes a wire set, a composite tube made of a light-transmitting material, and at least two LED lamp beads. The wire set includes a signal wire and a power wire. The at least two LED lamp beads are sequentially arranged and mounted on the signal wire and the power wire to form an LED strip, and two adjacent LED lamp beads are connected in series. The composite tube is coated on an outer side of the LED strip through an extrusion process. The composite tube includes a cable wire and a hollow tube integrally formed and coated on an outer side of the cable wire. The cable wire is configured to compensate for voltage drop loss generated after the power wire supplies power to the LED lamp beads, thereby ensuring normal operation of the LED lamp beads in the hollow tube.

And the cable wire is integrally formed with the hollow tube and wrapped between an inner wall and an outer wall of the hollow tube, and can be used to compensate for voltage drop loss generated by the power wire when multiple LED lamps are connected together. There is no need to strip the inner wall or outer wall of the hollow tube to expose the cable wire from the hollow tube and then connect the cable wire to the LED lamp beads or the power wire. Electrical conduction can be achieved through connection terminals. For example, both the cable wire and the power wire are connected to the connection terminals, and then multiple LED lamps are connected to each other through the connection terminals. The connection terminals can also be connected to an external power source, such that the external power source can supply power to the LED lamp beads through the connection terminals and the power wire. Or the external power source transmits power to the cable wire through the connection terminals, the cable wire then supplies power to the LED lamp beads through the power wire. This not only enables mass production, but also reduces manufacturing costs.

In the description of the present application, unless otherwise expressly specified and limited, the terms “mounting”, “connection”, and “connecting” are to be understood broadly. For example, they may refer to fixed connection, detachable connection, or integral connection. They may refer to mechanical connection or electrical connection. They may refer to direct connection or indirect connection through an intermediate medium, or internal communication between two components or interaction relationships between two components. For those of ordinary skill in the art, specific meanings of the above terms in the present application may be understood according to specific situations.

In the present application, unless otherwise expressly specified and limited, when a first feature is described as being “on” or “under” a second feature, it may include that the first and second features are in direct contact, or may include that the first and second features are not in direct contact but are in contact through another feature therebetween. Moreover, when a first feature is described as being “above”, “over”, or “on top of” a second feature, it includes that the first feature is directly above or obliquely above the second feature, or indicates that a horizontal height of the first feature is higher than that of the second feature. When a first feature is described as being “below”, “under”, or “beneath” a second feature, it includes that the first feature is directly below or obliquely below the second feature, or indicates that a horizontal height of the first feature is lower than that of the second feature.

The above disclosure provides many different embodiments or examples for implementing different structures of the present application. In order to simplify the disclosure of the present application, components and arrangements of examples are described above. These are examples and are not intended to limit the present application. In addition, reference numerals and/or reference letters may be repeated in different examples of the present application for simplicity and clarity, and such repetition itself does not indicate relationships between various embodiments and/or arrangements discussed.

The present application provides examples of various specific processes and materials. However, those of ordinary skill in the art may recognize application of other processes and/or use of other materials.

In the description of the present specification, references to “one embodiment”, “some embodiments”, “illustrative embodiments”, “examples”, “specific examples”, or “some examples” mean that features, structures, materials, or characteristics described in connection with the embodiment or example are included in at least one embodiment or example of the present application. In this specification, schematic representations of the above terms do not necessarily refer to the same embodiment or example. Moreover, the described features, structures, materials, or characteristics may be combined in any suitable manner in one or more embodiments or examples.

What is claimed is:

1. An LED lamp, comprising a wire set, a composite tube made of a light-transmitting material, and at least two LED lamp beads;
wherein the wire set comprises a signal wire and a power wire, the at least two LED lamp beads are sequentially arranged and mounted on the signal wire and the power wire to form an LED strip, two adjacent LED lamp beads are connected in series, and the composite tube is coated on an outer side of the LED strip and the LED lamp beads through an extrusion process;
the composite tube comprises a cable wire and a hollow tube, the cable wire is configured to compensate for voltage drop loss generated after the power wire supplies power to the LED lamp beads, and the hollow tube is integrally formed and coated on an outer side of the cable wire; the LED strip is disposed in a cavity formed by the hollow tube, such that light emitted by the LED lamp beads is capable of passing through the hollow tube and being transmitted to an outside of the hollow tube.

2. The LED lamp according to claim 1, wherein the cable wire is a metal wire, the metal wire is wrapped between an inner wall and an outer wall of the hollow tube, the LED strip is wrapped in the cavity formed by the inner wall of the hollow tube, and the LED strip and the metal wire are electrically insulated from each other inside the hollow tube.

3. The LED lamp according to claim 2, wherein the cable wire comprises a first power wire and a second power wire, and the first power wire and the second power wire are arranged along a length direction of the hollow tube and symmetrically disposed on two sides of the hollow tube.

4. The LED lamp according to claim 1, wherein the power wire comprises a positive power wire and a negative power wire, the positive power wire is connected to a positive pin of the LED lamp bead, the negative power wire is connected to a negative pin of the LED lamp bead, and an encapsulant is formed on an outer side of the LED lamp beads through a dispensing process.

5. The LED lamp according to claim 4, wherein the encapsulant at least wraps an outer side of connection points where the LED lamp beads join the positive power wire and the negative power wire respectively.

6. The LED lamp according to claim 4, wherein the signal wire comprises a signal output wire and a signal input wire, the signal output wire is connected to a signal output pin of the LED lamp beads, and the signal input wire is connected to a signal input pin of the LED lamp beads.

7. The LED lamp according to claim 6, wherein the positive power wire, the negative power wire, the signal output wire, and the signal input wire are arranged in parallel side by side to form a ribbon cable structure, and the positive power wire and the negative power wire are respectively located at two outer sides of the ribbon cable structure.

8. The LED lamp according to claim 1, wherein the LED lamp further comprises connection terminals electrically connected to the signal wire and the power wire, and the connection terminals are connected to two ends of the composite tube through an injection molding process.

9. The LED lamp according to claim 8, wherein the connection terminals comprise a first connection terminal and a second connection terminal that cooperate with each other, the first connection terminal is disposed at one end of the composite tube, and the second connection terminal is disposed at another end of the composite tube;
the first connection terminal is provided with a positive connector, a negative connector, and a signal input connector; the second connection terminal is provided with a positive connection port, a negative connection port, and a signal output connector; the positive power wire of the power wire and a first power wire of the cable wire are connected to the positive connector and the positive connection port, the negative power wire of the power wire and a second power wire of the cable wire are connected to the negative connector and the negative connection port; the signal input connector is connected to the signal input wire of the signal wire, the signal output connector is connected to the signal output wire of the signal wire; and the signal output pin of one LED lamp bead is electrically connected to the signal input pin of adjacent LED lamp bead.

10. An LED product, comprising a plurality of LED lamps according to claim 1, wherein the LED lamps are connected to each other through connection terminals on the composite tubes, and voltage drop loss generated on the power wire of the LED lamp beads is compensated through the cable wire between two adjacent LED lamps.
